(19) United States
(12) Patent Application Publication
(10) Pub. No.: US 2006/0191492 A1
(43) Pub. Date: Aug. 31, 2006

(54) Internal shoulder bars for squeeze chutes and the like

(76) Inventor: Barry Ross, Dawson Creek (CA)

Correspondence Address: Adams Evans P.A., 2180 Two Wachovia Center, 301 S. Tryon Street, Charlotte, NC, 28282, US

(21) Appl. No.: 11/223,257

(22) Filed: Sep. 9, 2005

(30) Foreign Application Priority Data
Feb. 28, 2005 (CA) 2,498,750

(51) Int. Cl. A01K 15/04

(52) U.S. Cl. 119/734

(57) ABSTRACT

A shoulder bar apparatus is adapted for attachment inside an animal chute comprising a headgate and side panels movably mounted on the chute frame. The apparatus comprises right and left vertical shoulder bars movably mounted to corresponding sides of the chute frame rearward of the headgate, each shoulder bar having a top end above a neck location and a bottom end below the neck location. A shoulder bar control mechanism is operative to simultaneously move the shoulder bars from an open position, where the shoulder bars are located in proximity to corresponding right and left sides of the chute frame, to a closed position where the shoulder bars are located in proximity to corresponding right and left sides of the neck location and behind headgate a distance about equal to the neck length of a confined animal. A lock is operative to maintain the shoulder bars in the closed position.

This invention is in the field of equipment for handling livestock animals such as cattle, and in particular chutes for confining animals.

### TECHNICAL FIELD AND BACKGROUND OF THE INVENTION

Chutes are used for confining cattle and like animals to allow for various procedures such as testing, vaccination, branding, and so forth. Conventional squeeze chutes include a squeeze mechanism to apply pressure to the sides of the animal. A headgate at the front end of the chute comprises a pair of bars that move together behind the animal's head on each side of the neck. The bars may be curved to follow the contours of the neck, and to prevent harm to the animal the bars do not close tightly against the neck such that the animal can move forward the distance between the head and shoulders. U.S. Pat. No. 5,111,773 to Akins discloses a typical cattle chute.

In order to prevent such forward and rearward movement of the animal, which is desirable for example to facilitate injections of medicine into the preferred neck area of the animal, head bars have been provided forward of the conventional headgate bars. U.S. Pat. No. 4,517,924 to McCan et al, and U.S. Pat. No. 6,666,169 to Dehod disclose such head bars forward of the conventional headgate. U.S. Pat. No. 3,777,715 to Hill et al. and U.S. Pat. No. 4,162,685 to Knappenberger disclose further head confining mechanisms located in front of the conventional headgate.

### SUMMARY OF THE INVENTION

It is an object of the present invention to provide a headgate that overcomes problems in the prior art.

The present invention provides, in a first embodiment, a shoulder bar apparatus for attachment inside an animal chute comprising a headgate at a front end of a chute frame, and side panels rearward of the headgate, the headgate and side panels movably mounted on the chute frame and operative to temporarily confine an animal with a neck of the animal extending through the head gate and side panels adjacent to a body of the animal. The shoulder bar apparatus comprises right and left substantially vertically oriented shoulder bars adapted to be movably mounted to corresponding sides of the chute frame rearward of the headgate, the shoulder bars each having a top end located above a neck location and a bottom end below the neck location. A shoulder bar control is operative to substantially simultaneously move the shoulder bars from an open position, where the shoulder bars are located in proximity to corresponding right and left sides of the chute frame, to a closed position where the shoulder bars are located in proximity to corresponding right and left sides of the neck location and rearward of the headgate a distance substantially equal to a length of a neck of a confined animal, and a lock is operative to maintain the shoulder bars in the closed position.

The present invention provides, in a second embodiment, an animal chute apparatus comprising a headgate at a front end of a chute frame, and side panels rearward of the headgate. The headgate and side panels are movably mounted on the chute frame and are operative to temporarily confine an animal with a neck of the animal extending through the head gate and the side panels adjacent to a body of the animal. Right and left substantially vertically oriented shoulder bars are movably mounted to corresponding sides of the chute frame rearward of the headgate, the shoulder bars each having a top end located above a neck location and a bottom end below the neck location. A shoulder bar control is operative to substantially simultaneously move the shoulder bars from an open position, where the shoulder bars are located in proximity to corresponding right and left sides of the chute frame, to a closed position where the shoulder bars are located in proximity to corresponding right and left sides of the neck location and rearward of the headgate a distance substantially equal to a length of a neck of a confined animal. A lock is operative to maintain the shoulder bars in the closed position.

The shoulder bars of the present invention minimize movement of the animal in the chute and prevent forward and rearward movement of the confined animal. On modern conventional squeeze chutes, doors are typically provided in the sides of the chute just rearward of the headgate to provide access to the neck for injections. An animal in a chute with the added shoulder bars of the invention can not move back and forth, and so injections in the neck are more readily performed

The internal shoulder bars of the present invention can be provided for installation on existing chutes as an after market modification, or can readily be added at the factory when building new chutes without requiring any substantial changes to the design of the conventional chute, thus reducing start-up costs. A chute with such internal shoulder bars is more compact than one with prior art shoulder bars extending in front of the conventional headgate.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an animal in a conventional squeeze chute of the prior art with the headgate and side panels in a closed position confining the animal;

FIG. 2 is a schematic top view of an animal entering the squeeze chute of FIG. 1 with the headgate and side panels in an open position to allow the animal to enter the chute;

FIG. 3 is a schematic top view of an animal in the squeeze chute of FIG. 1 with the headgate and side panels in a closed position, and showing the shoulder bars of the invention in a closed position, confining the animal;

FIG. 4 is a schematic top view of an animal entering the squeeze chute of FIG. 1 with the headgate and side panels in an open position, and showing the shoulder bars of the invention in an open position, to allow the animal to enter the chute;

FIG. 5 is a schematic side view of an animal in the squeeze chute of FIG. 1 with the headgate and side panels in a closed position, and showing the shoulder bars of the invention in a closed position, confining the animal;

FIG. 6 is a schematic top view of a top guide for the shoulder bars with the shoulder bars in the closed position;

FIG. 7 is a schematic top view of the top guide of FIG. 6 with the shoulder bars in the open position;

FIG. 8 is a schematic front view of a mechanism for moving the shoulder bars between the open and closed position, and for locking the shoulder bars in a selected position, with the shoulder bars shown in the closed position;

FIG. 9 is a schematic side view of an alternate shoulder bar and guide arrangement;

FIG. 10 is a schematic top view of an alternate mechanism for moving shoulder bars between the open and closed position.

### DETAILED DESCRIPTION OF THE PREFERRED EMBODIMENT AND BEST MODE

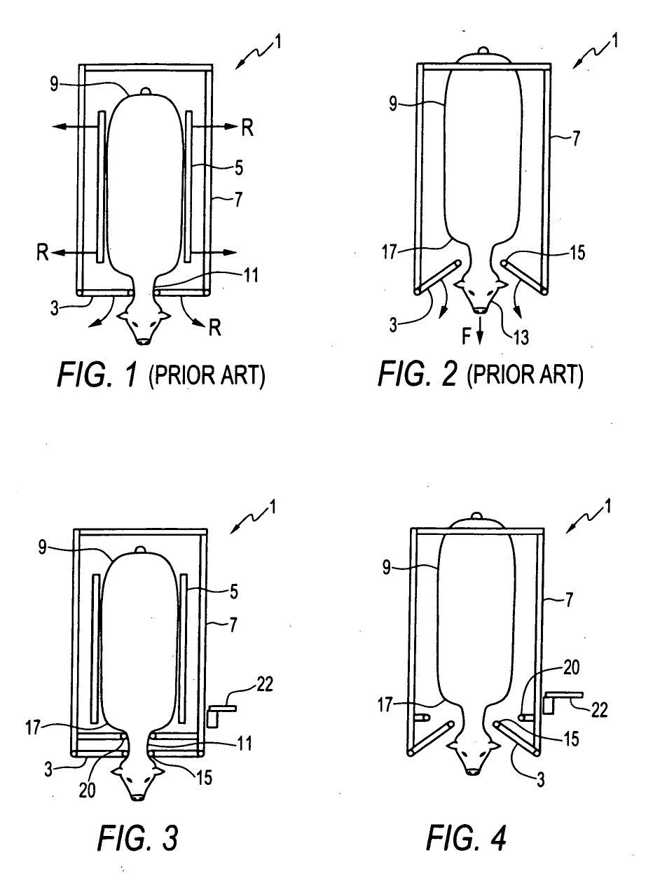

FIG. 1 schematically illustrates an animal squeeze chute 1 such as are known for use in animal husbandry. Such chutes comprise a headgate 3 at a front end of a chute frame 7, and side panels 5 rearward of the headgate 3. The headgate 3 and side panels 5 are movably mounted on a chute frame 7 and are operative to temporarily confine an animal 9 with a neck 11 of the animal 9 extending through the head gate 3 and side panels 5 located adjacent to a body of the animal 9. To release the animal 9, the headgate 3 and side panels 5 are moved away from the animal in the directions indicated by arrows R.

FIG. 2 illustrates an animal 9 entering the chute 1 in the forward direction F. While the headgate 3 is moved in the forward direction indicated by arrows R to release the animal as illustrated in FIG. 1, prior to another animal entering the chute the headgate is typically 20 moved backward to the entrance position illustrated in FIG. 2, such that when the animal 9 enters, its head 13 passes between the bars 15 of the headgate 3, but its shoulders 17 contact the bars 15, and push the headgate 3 to the closed position illustrated in FIG. 1. The headgate 3 latches in the closed position as the animal 9 moves forward.

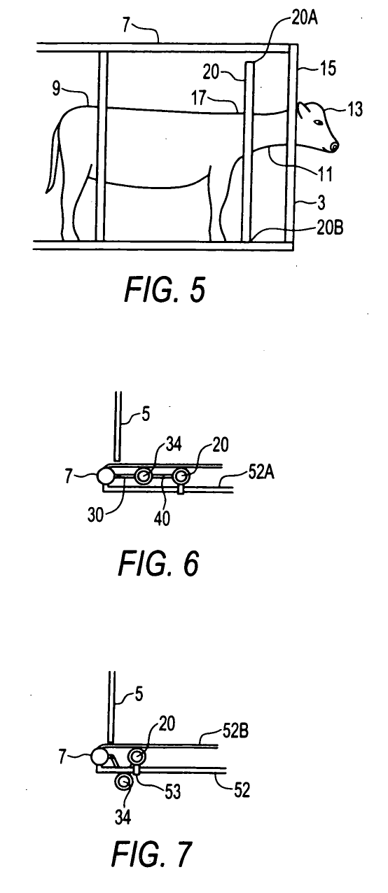

FIGS. 3-5 illustrate the chute 1 of FIG. 1 with an embodiment of the shoulder bar apparatus of the invention mounted thereon. The shoulder bar apparatus comprises right and left substantially vertically oriented shoulder bars 20 movably mounted to corresponding sides of the chute frame 7 rearward of the headgate 3, the shoulder bars have a top end 20A located above the location of the neck 11 and a bottom end 20B below the neck location.

A shoulder bar control 22 mechanism is operative to simultaneously move the shoulder bars 20 from the open position illustrated in FIG. 4 where the shoulder bars 20 are located in proximity to corresponding right and left sides of the chute frame 7, to the closed position illustrated in FIG. 3 where the shoulder bars 20 are located in proximity to corresponding right and left sides of the location of the neck 11. The shoulder bar control mechanism 22 includes a lock mechanism such that the shoulder bars 20 can be maintained in the closed position.

In the animal chute 1 with the attached shoulder bar apparatus of the invention the animal enters the chute 1 and the headgate 3 closes to confine the neck 11 from side to side movement, however the animal can still move forward and rearward the length of its neck between the shoulders 17 and head 13. The animal 9 is moving forward when the headgate 3 latches closed, and the animal 9 is forced to stop. Typically an animal 9 such as a cow will try to reverse direction and back up when forward motion is thus stopped. When the animal backs up such that its head 13 is against the headgate bars 15, the shoulder bar control mechanism 22 can be operated to move the shoulder bars 20 to the closed position, securing the animal from forward and rearward motion. If the animal 9 does not back up on its own, a wave of the hand or tap on the head 13 will generally cause the animal to back up so the shoulder bars 20 can be moved to the closed position.

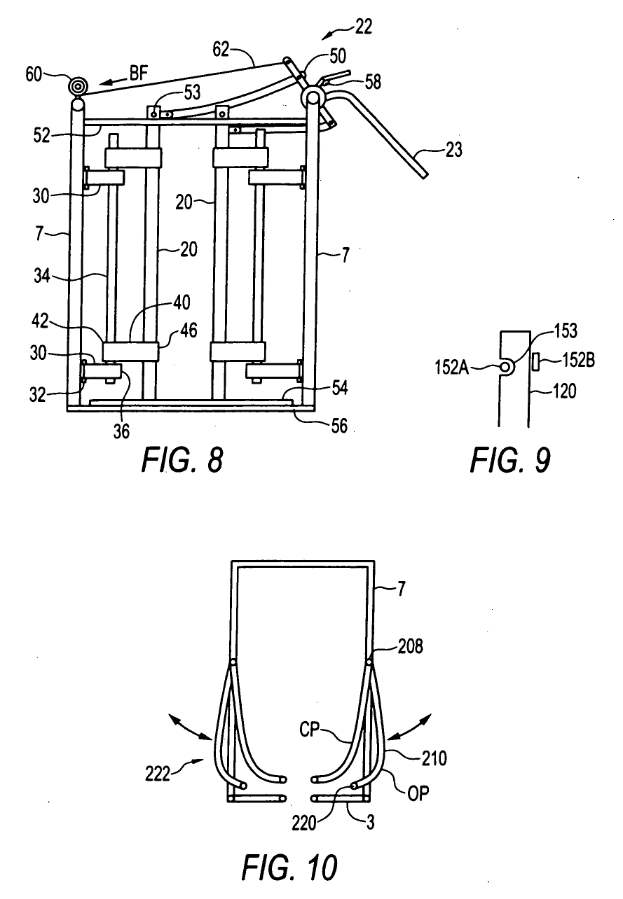

FIGS. 6-8 schematically illustrate a control mechanism 22 for moving the shoulder bars 20 laterally in a direction perpendicular to the side panels 5 from the open position of FIG. 7 to the closed position of FIGS. 6 and 8. The control mechanism 22 comprises first pivot arms 30 each pivotally attached to the frame 7 by hinges 32 at one end and pivotally attached to a vertical pivot bar 34 by sleeves 36 at the opposite end. Second pivot arms 40 each pivotal ly attached to the pivot bar 34 by sleeves 42 at one end and pivotally attached to the shoulder bar 20 by sleeves 46 at the opposite end. To minimize space, the pivot bar 34 is somewhat smaller in diameter than the shoulder bar 20.

A linkage 50 is attached to the frame 7 such that pulling down on the control handle 23 pulls the shoulder bars 20 together and into the closed position. Top ends of the shoulder bars 20 move along a top guide 52 comprising front and rear plates 52A, 52B fixed to the chute frame 7 and bottom ends of the shoulder bars 20 move along a bottom guide 54 fixed to the chute floor 56 when moving from the open position to the closed position. The guides 52, 54 prevent forward movement of the shoulder bars 20 when the animal pushes on them. The illustrated top guide 52 also prevents rearward motion of the shoulder bars 20, however any significant rearward movement of the animal is prevented by the headgate bars positioned against the neck directly behind the animal's head.

To help support the shoulder bars 20 vertically, a tab 53 extends from each shoulder bar 20 over the top of the front plate 52A and bears against, and slides along, the top of front plate 52A. Alternatively FIG. 9 illustrated an alternative wherein a groove 153 is provided in the shoulder bar 120 and the front member 152A of the top guide is provided by a tube or like member engaging the groove 153. Thus the front and rear members 152A, 152B of the top guide can be closer together, reducing the room needed for the apparatus.

The shoulder bars 20 are locked in the closed position by a lock comprising a ratchet mechanism 58, which may be released by applying closing pressure on the control handle 23 and releasing the catch. The ratchet mechanism 58 conveniently also is operative to maintain the shoulder bars 20 in any intermediate position between the open position and the fully closed position, such that various widths of animal necks can be accommodated. In the illustrated embodiment the shoulder bars 20 are biased toward the open position by a spring 60 connected to the linkage 50 by a cable 62. Thus when the catch on the ratchet mechanism 58 is released, the shoulder bars 20 are urged toward the open position. The First and second pivot arms 30, 40 can also be made adjustable to allow the distance between the shoulder bars 20 when in the closed position to be adjusted if required.

It is contemplated that other mechanisms could readily be adapted for moving the shoulder bars 20 between the open and closed positions and locking them at the desired position. FIG. 10 illustrates an alternate embodiment of the control mechanism 222 wherein the shoulder bars 220 are each pivotally attached to the chute frame 7 at a pivot location 208 by an arm 210. The shoulder bars 220 are located in proximity to corresponding right and left sides of a rear face of the headgate 3 when in the open position OP, and move pivotally inward and rearward to the closed position CP. Cables and linkages such as are known in the art can be provided to simultaneously move the shoulder bars 220 between the open and closed positions and lock same where desired. A bias element could be readily provided to urge the shoulder bars 220 to the open position when the lock was released. Top and bottom guides can be provided as required. The internal shoulder bars of the present invention can be provided for installation on existing chutes as an after market modification, or can readily be added at the factory when building new chutes without requiring any substantial changes to the design of the conventional chute, thus reducing start-up costs. A chute with such internal shoulder bars is more compact than one with prior art shoulder bars extending in front of the conventional headgate.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A shoulder bar apparatus for attachment inside an animal chute comprising a headgate at a front end of a chute frame, and side panels rearward of the headgate, the headgate and side panels movably mounted on the chute frame and operative to temporarily confine an animal with a neck of the animal extending through the head gate and side panels adjacent to a body of the animal, the shoulder bar apparatus comprising:
right and left substantially vertically oriented shoulder bars adapted to be movably mounted to corresponding sides of the chute frame rearward of the headgate, the shoulder bars each having a top end located above a neck location and a bottom end below the neck location;
a shoulder bar control mechanism operative to substantially simultaneously move the shoulder bars from an open position, where the shoulder bars are located in proximity to corresponding right and left sides of the chute frame, to a closed position where the shoulder bars are located in proximity to corresponding right and left sides of the neck location and rearward of the headgate a distance substantially equal to a length of a neck of a confined animal; and
a lock operative to maintain the shoulder bars in the closed position.

2. The apparatus of claim 1 wherein the lock is operative to maintain the shoulder bars in an intermediate position between the open position and the closed position.

3. The apparatus of claim 1 wherein the shoulder bars are biased toward the open position such that when the lock is released, the shoulder bars are urged toward the open position.

4. The apparatus of claim 1 wherein the shoulder bars move laterally in a direction substantially perpendicular to the side panels from the open position to the closed position.

5. The apparatus of claim 4 further comprising a bottom guide attachable to a floor of the chute and wherein the bottom ends of the shoulder bars move along the bottom guide when moving from the open position to the closed position.

6. The apparatus of claim 4 further comprising a top guide attachable to an upper portion of the chute frame and wherein the top ends of the shoulder bars move along the top guide when moving from the open position to the closed position,

7. The apparatus of claim 1 wherein the shoulder bars are located in proximity to corresponding right and left sides of a rear face of the headgate when in the open position, and move pivotally inward and rearward to the closed position.

8. An animal chute apparatus comprising:
a headgate at a front end of a chute frame, and side panels rearward of the headgate, wherein the headgate and side panels are movably mounted on the chute frame and are operative to temporarily confine an animal with a neck of the animal extending through the head gate and the side panels adjacent to a body of the animal;
right and left substantially vertically oriented shoulder bars movably mounted to corresponding sides of the chute frame rearward of the headgate, the shoulder bars each having a top end located above a neck location and a bottom end below the neck location;
a shoulder bar control mechanism operative to substantially simultaneously move the shoulder bars from an open position, where the shoulder bars are located in proximity to corresponding right and left sides of the chute frame, to a closed position where the shoulder bars are located in proximity to corresponding right and left sides of the neck location and rearward of the headgate a distance substantially equal to a length of a neck of a confined animal; and
a lock operative to maintain the shoulder bars in the closed position.

9. The apparatus of claim 8 wherein the lock is operative to maintain the shoulder bars in an intermediate position between the open position and the closed position.

10. The apparatus of claim 8 wherein the shoulder bars are biased toward the open position such that when the lock is released, the shoulder bars are urged toward the open position.

11. The apparatus of claim 8 wherein the shoulder bars move laterally in a direction substantially perpendicular to the side panels from the open position to the closed position.

12. The apparatus of claim 11 further comprising a bottom guide attachable to a floor of the chute and wherein the bottom ends of the shoulder bars move along the bottom guide when moving from the open position to the closed position.

13. The apparatus of claim 11 further comprising a top guide attachable to an upper portion of the chute frame and wherein the top ends of the shoulder bars move along the top guide when moving from the open position to the closed position.

14. The apparatus of claim 8 wherein the shoulder bars are located in proximity to corresponding right and left sides of a rear face of the headgate when in the open position, and move pivotally inward and rearward to the closed position.
